(19) United States
(12) Patent Application Publication
(10) Pub. No.: US 2023/0084324 A1
(43) Pub. Date: Mar. 16, 2023

(54) SOLID ION CONDUCTOR COMPOUND, SOLID ELECTROLYTE COMPRISING SAME, ELECTROCHEMICAL CELL COMPRISING SAME, AND MANUFACTURING METHOD THEREOF

(71) Applicant: SAMSUNG SDI CO., LTD., Yongin-si, Gyeonggi-do (KR)

(72) Inventors: Saebom RYU, Suwon-si, Gyeonggi-do (KR); Hyunseok KIM, Suwon-si, Gyeonggi-do (KR); Seoksoo LEE, Suwon-si, Gyeonggi-do (KR); Soyeon KIM, Suwon-si, Gyeonggi-do (KR); Shintaro KITAJIMA, Suwon-si, Gyeonggi-do (KR)

(21) Appl. No.: 17/797,917

(22) PCT Filed: Jan. 14, 2021
(86) PCT No.: PCT/KR2021/000565

§ 371 Date: Aug. 5, 2022

(30) Foreign Application Priority Data
Feb. 7, 2020 (KR) 10-2020-0015209

(51) Int. Cl. H01M 4/62; H01M 4/36; H01M 4/583; H01M 4/04; H01M 4/40

(52) U.S. Cl. CPC H01M 4/624; H01M 4/364; H01M 4/583; H01M 4/0404; H01M 4/405; H01M 4/0471; H01M 2004/027

(57) ABSTRACT

Disclosed are a solid ion conductor compound represented by Formula 1,
and having an argyrodite-type crystal structure, a solid electrolyte and an electrochemical cell each comprising the same, and a method of preparing the same:

LiₓP_{y}M1ᵥS_{z}M2_{w}M3_{w′} <Formula 1>
where in the above formula, M1 is an element substituted at P sites and having a larger ionic radius than that of P, M2 and M3 are different elements selected from elements of Group 17 in the periodic table, and 4≤x≤8, 0<y<1, 0<v<1, 0<z<6, 0<w<3, 0≤w′<3, and y≥v.

### CROSS-REFERENCE TO RELATED APPLICATION

This application claims the benefit of Korean Patent Application No. 10-2020-0015209, filed on Feb. 7, 2020, in the Korean Intellectual Property Office, the disclosure of which is incorporated herein in its entirety by reference.

### BACKGROUND

### 1. Field

The present disclosure relates to a solid ion conductor compound, a solid electrolyte and lithium battery comprising the same, and a method of preparing the same.

### 2. Description of the Related Art

An all-solid lithium battery includes a solid electrolyte used as an electrolyte. Since a combustible organic solvent is not contained in the all-solid lithium battery, the all-solid lithium battery is considered to have high stability. In developing high-performance all-solid batteries, development of solid electrolytes having high lithium ion conductivity is a crucial issue.

A sulfide-based solid electrolyte, which has soft characteristics, is capable of achieving a relatively high ionic conductivity of 10⁻³ Siemens per centimeter (S/cm) or greater simply by compressing powdered materials. Recently, many studies on sulfide-based solid electrolytes having an argyrodite-type crystal structure are underway owing to their desirable characteristics such as high ionic conductivity and stability with respect to lithium. However, the sulfide-based solid electrolyte having an argyrodite-type crystal structure is poor in terms of oxidation stability and moisture stability.

Although conventional LiPSCl-based argyrodite electrolytes have high ionic conductivity, they may have low oxidation stability, causing cathode interfacial reactions at a high-voltage area, thereby degrading charge/discharge characteristics. In addition, other problems with conventional argyrodite-type electrolytes, such as the generation of toxic gas, e.g., hydrogen sulfide, or reduction of ionic conductivity, may arise due to its high moisture reactivity.

Accordingly, research is needed to improve the oxidation stability and moisture stability of solid electrolytes.

### SUMMARY

In an aspect, provided is a solid ion conductor compound having improved activation energy, moisture stability and oxidation stability by inclusion of a novel composition.

In another aspect, provided is a solid electrolyte comprising the solid ion conductor compound.

In still another aspect, provided is an electrochemical cell comprising the solid ion conductor compound.

In still another aspect, provided is a preparation method of the solid ion conductor compound.

Additional aspects will be set forth in part in the description which follows and, in part, will be apparent from the description, or may be learned by practice of the presented embodiments of the disclosure. According to an aspect,

provided is a solid ion conductor compound represented by Formula 1

and having an argyrodite-type crystal structure:

LiₓP_{y}M1ᵥS_{z}M2_{w}M3_{w′} <Formula 1>

Wherein

M1 is an element substituted at P sites and having an ionic radius larger than that of P, M2 and M3 are different elements selected from elements of Group 17 in the periodic table, and 4≤x≤8, 0<y<1, 0<v<1, 0<z<6, 0<w<3, 0≤w′<3, and y≥v.

According to another aspect,

provided is a solid electrolyte including the solid ion conductor compound stated above.

According to still another aspect,

provided is an electrochemical cell comprising: a cathode layer including a cathode active material layer;

an anode layer including an anode active material layer; and

an electrolyte layer disposed between the cathode layer and the anode layer,

wherein the cathode layer and the anode layer each include the solid ion conductor compound stated above.

According to still another aspect,

provided is a preparation method of the solid ion conductor compound comprising the steps of: providing a mixture by contacting two or more compounds comprising: a lithium-containing compound; one or more compound containing an element, other than P, selected from elements belonging to Groups 3 to 15 in the periodic table and having an ionic radius larger than that of P; and different elements of Group 17 in the periodic table; and

thermally treating the mixture in an inert atmosphere in an inert atmosphere to provide the solid ion conductor compound.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows the measurement results of the ionic conductivities and activation energies of solid ion conductor compounds prepared in Examples 1 to 6 and Comparative Examples 1 to 3.

FIG. 2 shows changes in ionic conductivity according to storage time in solid ion conductor compounds prepared in Examples 1 to 3 and Comparative Example 2.

FIG. 3 shows the measurement results of ionic conductivity retention according to storage time in solid ion conductor compounds prepared in Examples 1 to 3 and Comparative Example 2.

FIG. 4 shows the discharge capacity recovery and retention measured after high-temperature storage of all-solid secondary batteries prepared in Examples 7 to 10 and Comparative Examples 4 and 5.

FIG. 5 shows the discharge capacities measured at various discharge rates of all-solid secondary batteries prepared in Examples 7, 8 and 10 and Comparative Example 5.

FIG. 6 shows the discharge capacity retention ratios measured at various discharge rates of all-solid secondary batteries prepared in Examples 7, 8 and 10 and Comparative Example 5.

FIG. 7 is a schematic view illustrating an embodiment of an all-solid secondary battery.

FIG. 8 is a schematic view illustrating another embodiment of an all-solid secondary battery according to another embodiment.

FIG. 9 is a schematic view illustrating still another embodiment of an all-solid secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various example embodiments are shown in the accompanying drawings. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. Like numerals refer to like elements throughout.

It will be understood that when an element is referred to as being “on” another element, it can be directly on the other element or intervening elements may be present. In contrast, when an element is referred to as being “directly on” another element, there are no intervening elements.

It will be understood that, although the terms first, second, third etc. may be used herein to describe various elements, components, regions, layers and/or sections, these elements, components, regions, layers and/or sections, should not be limited by these terms. These terms are only used to distinguish one element component, region, layer and/or section, from another. Thus, a first element, component, region, layer and/or section, discussed below could be termed a second element, component, region, layer and/or section, without departing from the teachings of the present inventive concept.

The terminology used herein is for the purpose of describing particular example embodiments only and is not intended to be limiting of the present inventive concept. As used herein, the singular forms are intended to include the plural forms including “at least one” as well, unless the context clearly indicates otherwise. In addition, a phrase “at least one” should not be construed as being limited to the singular forms. As used herein, the term “and/or” includes any and all combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of inventive concepts are described herein with reference to cross-sectional illustrations that are schematic illustrations of idealized embodiments of example embodiments. As such, variations from the shapes of the illustrations as a result, for example, of manufacturing techniques and/or tolerances, are to be expected. Thus, example embodiments of inventive concepts should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Group” means a group of the periodic table of the elements according to the International Union of Pure and Applied Chemistry (“IUPAC”) 1-18 Group classification system.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

Solid ion conductor compounds according to one or more example embodiments, solid electrolyte and electrochemical cells comprising the same and preparation methods thereof will now be described in further detail.

### [Solid Ion Conductor Compounds]

A solid ion conductor compound according to an embodiment is represented by Formula 1 and has an argyrodite-type crystal structure:

LiₓP_{y}M1ᵥS_{z}M2_{w}M3_{w′} <Formula 1>

where in the above formula,

M1 is an element substituted at P sites and having a larger ionic radius than that of P, M2 and M3 are different elements selected from elements of Group 17 in the periodic table, and 4≤x≤8, 0<y<1, 0<v<1, 0<z<6, 0<w<3, 0≤w′<3, and y≥v.

The solid ion conductor compound represented by Formula 1 is a crystalline compound having an argyrodite-type crystal structure, and may have improved ionic conductivity of lithium ion in the compound and reduced activation energy by the inclusion of the Element M1 substituted at part of the P sites in the crystal structure. For example, the solid ion conductor compound represented by Formula 1 may have an increased crystal lattice volume by the disposition or arrangement of the element having a larger ionic radius than P, at the part of the P sites in the compound. Since the migration of lithium ions in the crystal lattice is facilitated due to the increased crystal lattice volume, the solid ion conductor compound represented by Formula 1 may have a high ionic conductivity while reducing a change in the time-dependent ionic conductivity, thereby providing improved ionic conductivity retention ratio.

In addition, the solid ion conductor compound represented by Formula 1 may have improved structural stability by the arrangement of one or more of the M2 and M3 elements of Group 17 in the periodic table at some of the S sites, the one or more of the M2 and M3 elements having excellent moisture stability and/or oxidation stability. Since a compound having an argyrodite-type crystal structure contains a non-binding S atom having a high moisture or oxygen reactivity, toxic hydrogen sulfur may be produced when S is exposed to air, which is problematic. The moisture or oxygen stability of the argyrodite-type crystal structure can be improved by substitution of the part of the non-binding S with the one element M2 of Group 17 in the periodic table or by simultaneous substitution of the part of the S sites with two elements M2 and M3 of Group 17 in the periodic table. When the two different elements M2 and M3 selected from the elements of Group 17 in the periodic table are simultaneously replaced, the degree of halogen disorder is increased, and thus the structural stability can be improved, thereby further increasing the ionic conductivity and oxidation stability, compared to the case when only one element is replaced.

The solid ion conductor compound represented by Formula 1 may satisfy, for example, the following conditions: 0<v/(y+v)≤0.5; 0<v/(y+v)<0.5 0.1≤v/(y+v)<0.5; 0.1≤v/(y+v)≤0.4; 0.1≤v/(y+v)≤0.3; or 0.1≤v/(y+v)≤0.2.

The solid ion conductor compound represented by Formula 1 may satisfy for example, the following conditions: w+w′>0; w+w′≥0.1; w+w′≥0.5; or w+w′≥1.

The solid ion conductor compound represented by Formula 1 may satisfy for example, the following conditions: 0<(w+w′)/(z+w+w′)≤0.5; 0.1≤(w+w′)/(z+w+w′)<0.5; 0.1≤(w+w′)/(z+w+w′)≤0.4; or 0.1≤(w+w′)/(z+w+w′)≤0.3.

In the solid ion conductor compound represented by Formula 1, M1 may be one or more element, other than P, selected from Groups 3 to 15 elements.

In the solid ion conductor compound represented by Formula 1, M1 may comprise, for example, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, Bi, or a combination thereof.

In the solid ion conductor compound represented by Formula 1, M1 may comprise, for example, Si, Ge, Sn, or a combination thereof.

The amount v of the element M1 substituted at the P sites is less than or equal to the content y of phosphorus P. That is to say, y≥v. If the amount v of the element M1 substituted at the P sites is greater than the content y of phosphorus P, M1 does not exist in the argyrodite-type crystal structure but exists in the form of impurity, lowering the ionic conductivity and stability.

In the solid ion conductor compound represented by Formula 1, M2 and M3 may comprise, for example, different elements selected from F, Cl, Br, I, or a combination thereof.

The solid ion conductor compound represented by Formula 1 may be, for example, a solid ion conductor compound represented by Formula 2:

Li_{7+a-(b+c)}P₁₋ₐM1ₐS_{6-(b+c)}M2_{b}M3_{c} <Formula 2>

wherein in the formula 2,

M1 is Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, Bi, or a combination thereof,

M2 and M3 M2 and M3 are different elements selected from F, Cl, Br, I, or a combination thereof,

0<a≤0.5, 0<b<3, and 0≤c<3.

The solid ion conductor compound represented by Formula 2 may satisfy, for example, 0<a<0.5 and b+c≥1. The solid ion conductor compound represented by Formula 2 may satisfy, for example, 0<a<0.3 and b+c≥1. In the range stated above, the solid ion conductor compound represented by Formula 2 may have a higher ionic conductivity.

The solid ion conductor compound represented by Formula 1 may be a solid ion conductor compound represented by at least one of Formulae 2a to 2c below:

Li_{7+a-(b+c)}P₁₋ₐGeₐS_{6-(b+c)}M2_{b}M3_{c}; <Formula 2a>

Li_{7+a-(b+c)}P₁₋ₐSiₐS_{6-(b+c)}M2_{b}M3_{c}; and <Formula 2b>

Li_{7+a-(b+c)}P₁₋ₐSnₐS_{6-(b+c)}M2_{b}M3_{c} <Formula 2c>

where in the formulae above, M2 and M3 are different elements selected from F, Cl, Br, I, or a combination thereof, 0<a≤0.5, 0<b<3, 0≤c<3 and b+c≥1.

The solid ion conductor compound represented by Formula 1 may be a solid ion conductor compound represented by at least one of Formulae below:

Li_{7+a-(b+c)}P₁₋ₐGeₐS_{6-(b+c)}Cl_{b}Br_{c}; Li_{7+a-(b+c)}P₁₋ₐSiₐS_{6-(b+c)}Cl_{b}Br_{c}; Li_{7+a-(b+c)}P₁₋ₐSnₐS_{6-(b+c)}Cl_{b}Br_{c};

Li_{7+a-(b+c)}P₁₋ₐGeₐS_{6-(b+c)}Cl_{b}I_{c}; Li_{7+a-(b+c)}P₁₋ₐSiₐS_{6-(b+c)}Cl_{b}I_{c}; Li_{7+a-(b+c)}P₁₋ₐSnₐS_{6-(b+c)}Cl_{b}I_{c};

Li_{7+a-(b+c)}P₁₋ₐGeₐS_{6-(b+c)}Br_{b}I_{c}; Li_{7+a-(b+c)}P₁₋ₐSiₐS_{6-(b+c)}Br_{b}I_{c}; and Li_{7+a-(b+c)}P₁₋₁SnₐS_{6-(b+c)}P₁₋ₐSnₐS_{6-(b+c)}Br_{b}I_{c},

where in the above formulae, 0<a≤0.5, 0≤b<3, 0≤c<3 and b+c≥1.

The solid ion conductor compound represented by Formula 1 may have part of Li sites further substituted with at least one element M4 selected from elements of Groups 1 to 15 in the periodic table. For example, the at least one element M4 selected from elements of Groups 1 to 15 in the periodic table may comprise Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof. The solid ion conductor compound represented by Formula 1 may have further improved ionic conductivity of lithium ions in the compound and further reduced activation energy by inclusion of an element M4 substituted at the part of the Li sites in the crystal structure. For example, when an ion having a larger oxidation number than Li ion, that is, 2 or greater, is disposed in the part of the Li sites in the solid ion conductor compound represented by Formula 1, the part of the Li sites may become vacant sites. The migration of lithium ions in the crystal lattice may be facilitated by existence of the vacant sites in the crystal lattice.

For example, the element M4 substituted at the part of the Li sites may be at least one selected from elements of Groups 1, 2 and 11 in the periodic table. For example, the element M4 may comprise Na, K, Mg, Ag, Cu, or a combination thereof.

In Formula 1, when the substitution amount of the at least one element M4 selected from elements of Groups 1 to 15 in the periodic table is denoted by u, 0<u<0.5.

The solid ion conductor compound represented by Formula 1 may have the part of the S sites further substituted with SOₙ, where 1.5≤n≤5. Since the solid ion conductor compound represented by Formula 1 has the part of the S sites substituted with SOₙ, the ionic conductivity of lithium ions in the compound may be further improved, and the activation energy thereof may be further reduced. In addition, since SOₙ including oxygen atoms having better oxidation stability than the S atom is doped into the S site, the structural stability of the compound can be further enhanced.

Examples of SOₙ substituted at the part of the S sites may include S₄O₆, S₃O₆, S₂O₃, S₂O₄, S₂O₅, S₂O₆, S₂O₇, S₂O₈, SO₄, SO₅, or a combination thereof. SOₙ may be, for example, a monovalent anion or a divalent anion. Examples of the divalent anion SOₙ²⁻ may include S₄O₆²⁻, S₃O₆²⁻, S₂O₃²⁻, S₂O₄²⁻, S₂O₅²⁻, S₂O₆²⁻, S₂O₇²⁻, S₂O₈²⁻, SO₄²⁻, SO₅²⁻, or a combination thereof.

In Formula 1, when the substitution amount of the SOₙ is denoted by u′, 0<u′<2.

The solid ion conductor compound represented by Formula 1 may provide an improved lithium ionic conductivity. The solid ion conductor compound represented by Formula 1 may provide an ionic conductivity of, for example, about 1.0 mS/cm or greater, about 1.5 mS/cm or greater, about 2.0 mS/cm or greater, about 2.5 mS/cm or greater, about 3.0 mS/cm or greater, about 3.5 mS/cm or greater, about 4.0 mS/cm or greater, or about 5.0 mS/cm or greater at room temperature, e.g. 25° C. Therefore, in an electrochemical cell comprising: a cathode; an anode; and the solid ion conductor compound represented by Formula 1, interfacial resistance between the cathode and the anode may be reduced by effectively performing ionic transfer between the cathode and the anode. The ionic conductivity may be measured by employing a DC polarization method. Alternatively, the ionic conductivity may be measured by employing impedance spectroscopy.

The solid ion conductor compound represented by Formula 1 may have an ionic conductivity retention ratio of, for example, about 70% or greater, about 75% or greater, or about 80% or greater, after exposure to dry air at a dew point of lower than −60° C. for 10 days. The ionic conductivity retention ratio is represented by Equation 1 below. In the Equation below, the initial ionic conductivity of the solid ion conductor compound means an ionic conductivity before storing the solid ion conductor compound under drying conditions. The ionic conductivity retention ratio may be measured by the method disclosed in Evaluation Example 3.

Ionic conductivity retention ratio=[Ionic conductivity of solid ion conductor compound after 10 days/Initial ionic conductivity of solid ion conductor compound]×100. <Equation 1>

The solid ion conductor compound represented by Formula 1 may belong to, for example, a cubic crystal system, specifically an F43m space group crystal structure. In addition, the solid ion conductor compound represented by Formula 1 may be an argyrodite-type sulfide having an argyrodite-type crystal structure. The solid ion conductor compound represented by Formula 1 may provide an improved lithium ion conductivity by the substitution of the part of the P sites in the argyrodite-type crystal structure with the M2 element having a larger ionic radius than that of P. In addition, the solid ion conductor compound represented by Formula 1 may provide improved oxidation resistance and moisture stability with respect to lithium metal by the substitution of some of the S sites in the argyrodite-type crystal structure with one element, i.e., the M2 element of Group 17 in the periodic table or by simultaneous substitution of some of the S sites with two elements, i.e., the M2 and M3 elements of Group 17 in the periodic table.

In addition, the solid ion conductor compound represented by Formula 1 may have a peak appearing at a diffraction angle of, for example, 25.48°±0.50°, 30.01°±0.50°, 31.38°±0.50°, 46.0°±1.0°, 48.5°±1.0°, or 53.0°±1.0° by X-ray diffraction (XRD) analysis using Cu Kα radiation. Such peaks of the solid ion conductor compound represented by Formula 1, as determined by XRD analysis using Cu Kα radiation, may be attributed to its argyrodite-type crystal structure.

### Solid Electrolyte

According to another embodiment, a solid electrolyte includes the solid ion conductor compound represented by Formula 1. The solid electrolyte may have a high ionic conductivity and a high chemical stability by the inclusion of such a solid ion conductor compound. The solid electrolyte including the solid ion conductor compound represented by Formula 1 may be stable with respect to air and may provide electrochemical stability with respect to a lithium metal. Therefore, the solid ion conductor compound represented by Formula 1 may be used as, for example, a solid electrolyte of an electrochemical cell.

The solid electrolyte may additionally include a conventional general solid electrolyte in addition to the solid ion conductor compound represented by Formula 1. The solid electrolyte may additionally include, for example, a conventional general sulfide-based solid electrolyte and/or a conventional general oxide-based solid electrolyte. Examples of the conventional general solid ion conductor compound additionally included in the solid electrolyte may include, but not limited to, lithium aluminum titanium phosphate (LATP) (e.g., Li₂O—Al₂O₃—TiO₂—P₂O₅), a lithium superionic conductor (LiSICON) (e.g., Li₂₊₂ₓZn₁₋ₓGeO₄), lithium phosphorous oxynitride (LIPON) (e.g., Li_{3+y}PO₄₋ₓNₓ, where 0<y<3 and 0<x<4), thio-LiSICON (e.g., Li_{3.25}Ge_{0.25}P_{0.75}S₄), Li₂S, Li₂S—P₂S₅, Li₂S—SiS₂, Li₂S—GeS₂, Li₂S—B₂S₅, and Li₂S—Al₂S₅, and any solid ion conductor compound available in the art may be used.

The solid electrolyte may be in form of powder or a molding. The molding form may be, for example, a pellet, a thin film, or the like, but is not limited thereto, and may have various forms according to the use purpose thereof.

### Electrochemical Cell

According to another embodiment, an electrochemical cell includes a cathode layer including a cathode active material layer, an anode layer including an anode active material layer, and an electrolyte layer disposed between the cathode layer and the anode layer, wherein the cathode layer and the anode layer each include the solid ion conductor compound represented by Formula 1. The electrochemical cell may have improved lithium ion ionic conductivity and stability with respect to a lithium metal by the inclusion of the solid ion conductor compound represented by Formula 1.

Examples of the electrochemical cell may include, but not limited to, an all-solid secondary battery, a liquid electrolyte containing secondary battery, or a lithium air battery, and any electrochemical cell available in the art may be used.

Hereinafter, the all-solid secondary battery will be described in further detail.

### [All-Solid Secondary Battery: First Type]

The all-solid secondary battery may include a solid ion conductor compound represented by Formula 1.

The all-solid secondary battery may include, for example, a cathode layer including a cathode active material layer, an anode layer including an anode active material layer, and an electrolyte layer disposed between the cathode layer and the anode layer, wherein the cathode layer and/or the anode layer each include the solid ion conductor compound represented by Formula 1.

An all-solid secondary battery according to an embodiment may be prepared in the following manner.

### (Solid Electrolyte Layer)

First, a solid electrolyte layer is prepared.

The solid electrolyte layer may be prepared by mixing the solid ion conductor compound represented by Formula 1 with a binder and drying the mixture, or by rolling powder of the solid ion conductor compound represented by Formula 1 in a constant shape with a pressure of 1 to 10 tons. The solid ion conductor compound represented by Formula 1 is used as a solid electrolyte.

The solid electrolyte may have an average particle diameter in a range of, for example, 0.5 μm to 20 μm. The solid electrolyte particles may have improved binding capability during formation of a sintered body due to the average particle diameter of the solid electrolyte, thereby providing improved ionic conductivity and enhanced lifetime characteristic.

The solid electrolyte may have a thickness in a range of 10 μm to 200 μm. Sufficiently fast migration of lithium ions can be ensured by the thickness being in such a range, thereby consequently providing a high ionic conductivity.

The solid electrolyte layer may further a conventional general solid electrolyte such as a conventional sulfide-based solid electrolyte or a conventional oxide-based solid electrolyte in addition to the solid ion conductor compound represented by Formula 1.

Examples of the conventional sulfide-based solid electrolyte may include lithium sulfide, silicon sulfide, phosphorus, boron, or a combination thereof. Examples of the conventional oxide-based solid electrolyte may include Li₂S, P₂S₅, SiS₂, GeS₂, B₂S₃, or a combination thereof. Examples of conventional sulfide-based solid electrolyte particles may include Li₂S or P₂S₅. It is known that the conventional sulfide-based solid electrolyte particles have higher lithium ion conductivity than other inorganic compound particles. For example, the conventional sulfide-based solid electrolyte includes Li₂S and P₂S₅. When a sulfide solid electrolyte material constituting the conventional sulfide-based solid electrolyte includes Li₂S—P₂S₅, Li₂S and P₂S₅ are mixed at a molar ratio in a range of, for example, about 50:50 to about 90:10. In addition, usable examples of the conventional sulfide solid electrolyte may include an inorganic solid electrolyte prepared by adding lithium phosphate (Li₃PO₄), a halogen, a halogen compound, a lithium superionic conductor (LiSICON) (e.g., Li₂₊₂ₓZn₁₋ₓGeO₄), lithium phosphorous oxynitride (LIPON) (e.g., Li_{3+y}PO₄₋ₓNₓ), thio-LiSICON (e.g., Li_{3.25}Ge_{0.25}P_{0.75}S₄), or lithium aluminum titanium phosphate (LATP) (e.g., Li₂O—Al₂O₃—TiO₂—P₂O₅) to an inorganic solid electrolyte such as Li₂S-P₂S₅, SiS₂, GeS₂, B₂S₃, or a combination thereof. Non-limiting examples of the sulfide solid electrolyte material include: Li₂S—P₂S₅; Li₂S—P₂S₅—LiX (X is a halogen atom); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ, where m and n are positive numbers, and Z is Ge, Zn or G; Li₂S—GeS₂; Li₂S—SiS₂—Li₃PO₄; and Li₂S—SiS₂—LiₚMO_{q}, where p and q are positive numbers, and M is P, Si, Ge, B, Al, Ga or In. In this regard, the sulfide solid electrolyte material include may be prepared by performing melt quenching or mechanical milling treatment may be performed on starting materials (e.g., Li₂S or P₂S₅) In addition, a calcination process may be performed after the treatment.

Examples of the binder contained in the solid electrolyte layer include, but not limited to, styrene-butadiene rubber (SBR), polytetrafluoroethylene, polyvinylidene fluoride, polyethylene, polyvinyl alcohol, and so on, but any binder available in the art may be used as the binder. The binder of the solid electrolyte layer may be the same as or different from the binder used in a cathode or an anode.

### (Cathode Layer)

First, a cathode layer is prepared.

The cathode layer may be prepared by forming a cathode active material layer including a cathode active material on a current collector. The cathode active material may have an average particle diameter in a range of, for example, 2 μm to 10 μm.

As the cathode active material, any suitable cathode active material generally used in the art may be used without limitation. Examples of the cathode active material may include lithium transition metal oxide, or transition metal sulfide. Examples of the useful lithium transition metal may include one or more oxide composites of lithium and cobalt, manganese, nickel, or a combination thereof, and specific examples thereof may include one or more compounds represented by the formulae LiₐA_{1-b}B_{b}D₂, where 0.90≤a≤1.8, and 0≤b≤0.5; LiₐE_{1-b}B_{b}O_{2-c}D_{c}, where 0.90≤a≤1.8, 0≤b≤0.5, and 0≤c≤0.05; LiE_{2-b}B_{b}O_{4-c}D_{c}, where 0≤b≤0.5, and 0≤c≤0.05; LiₐNi_{1-b-c}Co_{b}B_{c}D_{α}, where 0.90≤a≤1.8, 0≤b≤0.5, 0≤c≤0.05, and 0<α≤2; LiₐNi_{1-b-c}Co_{b}B_{c}O₂₋ₐFₐ, where 0.90≤a≤1.8, 0≤b≤0.5, 0≤c≤0.05, and 0<α<2; LiₐNi_{1-b-c}Co_{b}B_{c}O_{2-α}F₂, where 0.90≤a≤1.8, 0≤b≤0.5, 0≤c≤0.05, and 0<α<2; LiₐNi_{1-b-c}Mn_{b}B_{c}D_{α}, where 0.90≤a≤1.8, 0≤b≤0.5, 0≤c≤0.05, and 0<α≤2; LiₐNi_{1-b-c}Mn_{b}B_{c}O_{2-α}F_{α}, where 0.90≤a≤1.8, 0≤b≤0.5, 0≤c≤0.05, and 0<α<2; LiₐNi_{1-b-c}Mn_{b}B_{c}O_{2-α}F₂, where 0.90≤a≤1.8, 0≤b≤0.9, 0≤c≤0.5, and 0.001≤d≤0.1; LiₐNi_{b}Co_{c}Mn_{d}GeO₂, where 0.90≤a≤1.8, 0≤b≤0.9, 0≤c≤0.5, 0≤d≤0.5, and 0.001≤e≤0.1; LiₐNiG_{b}O₂, where 0.90≤a≤1.8, and 0.001≤b≤0.1; LiₐCoG_{b}O₂, where 0.90≤a≤1.8, and 0.001≤b≤0.1; LiₐMnG_{b}O₂, where 0.90≤a≤1.8, and 0.001≤b≤0.1; LiₐMn₂G_{b}O₄, where 0.90≤a≤1.8, and 0.001≤b≤0.1; QO₂; QS₂; LiQS₂; V₂O₅; LiV₂O₂; LiIO₂; LiNiVO₄; Li_{(3-f)}J₂(PO₄)₃, where 0≤f≤2; Li_{(3-f)}Fe₂(PO₄)₃(0≤f≤2); and LiFePO₄. In the formulae above, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, a combination thereof; J is V, Cr, Mn, Co, Ni, Cu, or a combination thereof. For example, LiCoO₂, LiMnₓO₂ₓ (x=1 or 2), LiNi₁₋ₓMnₓO₂ₓ (0<x<1), Ni_{1-x-y}CoₓMn_{y}O₂ (0≤x≤0.5 and 0≤y≤0.5), Ni_{1-x-y}CoₓAl_{y}O₂ (0≤x≤0.5 and 0≤y≤0.5), LiFePO₄, TiS₂, FeS₂, TiS₃, or FeS₃ may be used. In these compounds, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof. Of course, a compound having a coating layer added to the surface of the above compound may also be used, or a mixture of the above compound and the coating layer added compound may also be used. This coating layer added to the surface of the composition may include a coating element compound such as an oxide of a coating element, a hydroxide of a coating element, an oxyhydroxide of a coating element, an oxycarbonate of a coating element, or a hydroxycarbonate of a coating element. The compound constituting the coating layer may be amorphous or crystalline. As the coating element included in the coating layer, Mg, Al, Co, K, Na, Ca, Si, Ti, V, Sn, Ge, Ga, B, As, Zr, or a combination thereof may be used. In the process of forming the coating layer, any suitable coating method may be used as long as it does not adversely affect the physical properties of the cathode active material. The coating method may be, for example, spray coating or immersing. Since details of the coating method can be well comprehended by one skilled in the art, a detailed description will not be given.

The cathode active material may include, for example, a lithium salt of a transition metal oxide having a layered rock salt type structure among the above-described lithium transition metal oxides. The layered rock-salt structure refers to a structure in which oxygen layers and metal atom layers are alternatively arrayed regularly in the direction of the [111] axis of a cubic rock salt type structure, thereby the respective atom layers form a two-dimensional plane. The cubic rock salt type structure refers to a NaCl type structure as a crystal structure, specifically a structure in which face-centered cubic (fcc) lattices respectively formed by each of cations and anions are shifted by half the ridge of each unit lattice. An example of the lithium salt of the transition metal oxide having the layered rock-salt structure may include a lithium salt of a ternary transition metal oxide, such as LiNiₓCo_{y}Al_{z}O₂ (NCA) or LiNiₓCo_{y}Mn_{z}O₂ (NCM), wherein 0<x<1, 0<y<1, 0<z<1, and x+y+z=1. When the cathode active material includes the ternary transition metal oxide having the layered rock-salt structure, the all-solid secondary battery 1 may have further improved energy density and thermal stability.

The cathode active material particle may be covered by the coating layer, as described above. Any coating layer that is known as a suitable coating layer for a cathode active material of an all-solid secondary battery in the art may be used. The coating layer may include, for example, Li₂O—ZrO₂ (LZO).

When the cathode active material may include a ternary lithium transition metal oxide, such as NCA or NCM, containing nickel (Ni), the capacity density of the all-solid secondary battery may be increased, thereby reducing the metal elution from the cathode active material at a charged state. Consequently, the all-solid secondary battery may have improved cycle characteristics at a charged state.

The cathode active material may have a shape that is, for example, a spherical particle shape or an oval particle shape. A particle diameter of the cathode active material is not particularly limited, and may be in a range applicable to a cathode active material for a general all-solid secondary battery. In addition, an amount of the cathode active material for the cathode layer is not particularly limited, and may be in a range applicable to a cathode active material for a general all-solid secondary battery. The amount of the cathode active material for the cathode layer may be in a range of, for example, 50% to 95% by weight.

The cathode active material may further include the solid ion conductor compound represented by Formula 1.

The cathode active material may include a binder. Examples of the binder may include styrene butadiene rubber (SBR), polytetrafluoroethylene, polyvinylidene fluoride, or polyethylene.

The cathode active material may include a conductive agent. Examples of the conductive agent may include graphite, carbon black, acetylene black, Ketjen black, carbon fiber, or metallic powder.

The cathode active material may further include a filler, a coating agent, a dispersant, or an ion conductive coagent in addition to the cathode active material, the solid electrolyte, the binder and the conductive agent.

Known materials that are generally used as the filler, the coating agent, the dispersant, or the ion conductive coagent in an electrode of the all-solid secondary battery, may be used.

A cathode current collector may be, for example, a plate type or a foil type, made of, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or a combination thereof. The use of the cathode current collector may be omitted.

The cathode current collector may further include a carbon layer disposed on one surface or both surfaces of a metal base member. The metal of the metal base member may be prevented from corroding by the solid electrolyte included in the cathode layer by further disposition or arrangement of the carbon layer on the metal base member, thereby reducing interfacial resistance. The carbon layer may have a thickness in a range of 1 μm to 5 μm. If the carbon layer is excessively thin, it is difficult to completely preclude the metal base member and the solid electrolyte from contacting each other. If the carbon layer is excessively thick, the energy density of the all-solid secondary battery may be lowered. The carbon layer may include amorphous carbon, or crystalline carbon.

### (Anode Layer)

Next, an anode layer is prepared.

The anode layer may be prepared by the same method used to prepare the cathode layer, except that an anode active material, instead of the cathode active material, is used. The anode layer may be prepared by forming an anode active material layer including an anode active material on an anode current collector.

The anode active material layer may further include the solid ion conductor compound represented by Formula 1.

The anode active material may be a lithium metal, a lithium metal alloy, or a combination thereof.

The anode active material layer may further include a conventional anode active material, in addition to the above anode active material containing a lithium metal, a lithium metal alloy, or a combination thereof. The conventional anode active material may include, for example, at least one selected from the group consisting of a metal alloyable with lithium, a transition metal oxide, a non-transition metal oxide and a carbonaceous material. Examples of the metal that is alloyable with lithium may include Ag, Si, Sn, Al, Ge, Pb, Bi, Sb Si—Y alloy where Y is an alkali metal, an alkali earth metal, a Group 13 element, a Group 14 element, a transition metal, a rare-earth element or a combination thereof, but is not Si; and an Sn—Y alloy where Y is an alkali metal, alkali earth metal, a Group 13 element, a Group 14 element, a transition metal, a rare-earth element or a combination thereof, but is not Sn. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. Examples of the transition metal oxide include lithium titanium oxide, vanadium oxide, and lithium vanadium oxide. For example, the non-transition metal oxide may be SnO₂ or SiOₓ where 0<x≤2. Examples of the carbonaceous material include crystalline carbon, amorphous carbon, and mixtures thereof. Examples of the crystalline carbon may include natural graphite and artificial graphite, each of which may have an amorphous shape, a plate shape, a flake shape, a spherical shape, or a fiber shape, and examples of the amorphous carbon may include soft carbon (low-temperature calcined carbon), hard carbon, mesophase pitch carbon, and calcined coke.

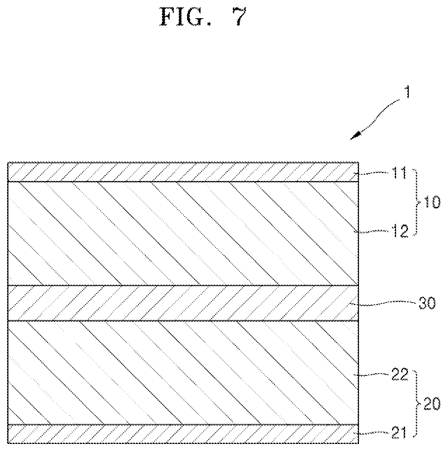

Referring to FIG. 7, an all-solid-state secondary battery 1 according to an embodiment includes a solid electrolyte layer 30, a cathode layer 10 disposed on one surface of the solid electrolyte layer 30, and an anode layer 20 disposed on the other surface of the solid electrolyte layer 30. The cathode layer 10 includes a cathode active material layer 12 that contacts the solid electrolyte layer 30 and a cathode current collector 11 that contacts the cathode active material layer 12, and the anode layer 20 includes an anode active material layer 22 that contacts the solid electrolyte layer 30 and an anode current collector 21 that contacts the anode active material layer 22. The all-solid secondary battery 40 may be completed by, for example, forming the cathode active material layer 12 and the anode active material layer 22 on both surfaces of the solid electrolyte layer 30, and forming the cathode current collector 11 and the anode current collector 21 on the cathode active material layer 12 and the anode active material layer 22, respectively. Alternatively, the all-solid secondary battery 40 may be completed by, for example, sequentially stacking the anode active material layer 22, the solid electrolyte layer 30, the cathode active material layer 12 and the cathode current collector 11 on the anode current collector 21.

### [All-Solid Secondary Battery: Second Type]

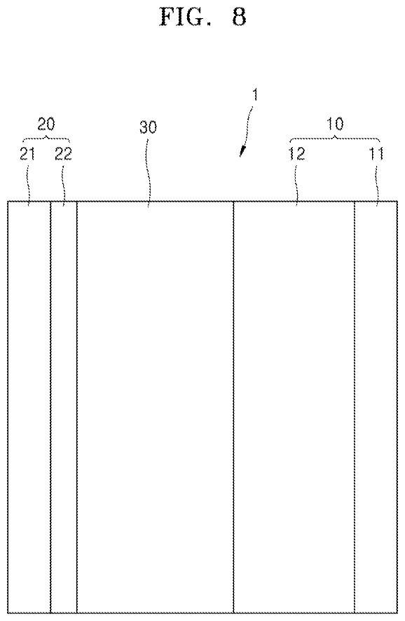

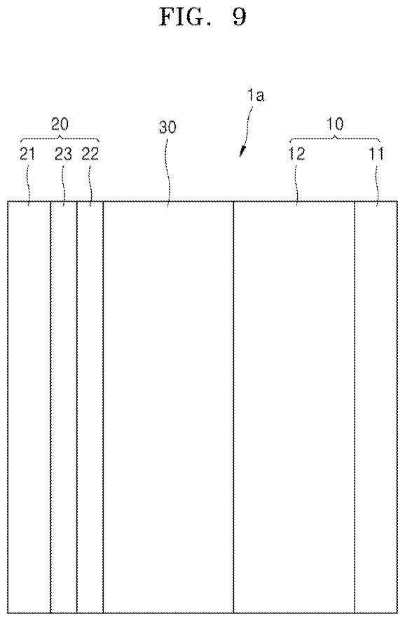

Referring to FIGS. 8 and 9, an all-solid secondary battery 1 may include: a cathode layer 10 including a cathode active material layer 12 disposed on a cathode current collector 11; an anode layer 20 including an anode active material layer 22 disposed on an anode current collector 21; and an electrolyte layer 30 disposed between the cathode layer 10 and the anode layer 20, the cathode layer 12 and/or the electrolyte layer 30 including the solid ion conductor compound represented by Formula 1.

An all-solid secondary battery according to another embodiment may be prepared in the following manner.

The cathode layer and the solid electrolyte layer may be prepared by the same method used to prepare the all-solid secondary battery described above.

### (Anode Layer)

An anode layer is prepared.

Referring to FIGS. 8 and 9, the anode layer 20 includes an anode current collector 21 and an anode active material layer 22 disposed on the anode current collector 21, and the anode active material layer 22 includes, for example, an anode active material and a binder.

The anode active material included in the anode active material layer 22 may be, for example, a particle type. An average particle diameter of the particle-type anode active material is in a range of, for example, 4 micrometers (μm) or less, 3 μm or less, 2 μm or less, 1 μm or less, or 900 nanometers (nm) or less. The average particle diameter of the particle-type anode active material is in a range of, for example, 10 nm to 4 μm, 10 nm to 3 μm, 10 nm to 2 μm, 10 nm to 1 μm, or 10 nm to 900 nm. Reversible intercalation and/or deintercalation of lithium ions can be facilitated during charging and discharging by the average particle diameter of the anode active material being within the range above. The average particle diameter of the anode active material is a median particle diameter D50 measured by a laser type particle size distribution measuring apparatus.

The anode active material in the anode active material layer 22 may be, for example, at least one selected from a carbonaceous anode active material and a metal or metalloid anode active material.

Specifically, the carbonaceous anode active material may be amorphous carbon. Examples of the amorphous carbon may include, but not limited to, carbon black (CB), acetylene black (AB), furnace black (FB), Ketjen black (KB), and graphene, and any suitable material that is classified as amorphous carbon in the art may be used. The amorphous carbon may be carbon having little crystallinity or extremely low crystallinity and is distinguished from crystalline carbon or graphite-based carbon.

Examples of the metal or metalloid anode active material may include, but not limited to one or more selected from the group consisting of gold (Au), platinum (Pt), palladium (Pd), silicon (Si), silver (Ag), aluminum (Al), bismuth (Bi), tin (Sn), and zinc (Zn), and any suitable metal or metalloid anode active material that is alloyable with lithium or capable of forming a compound in the art may be used. For example, nickel (Ni) is not alloyable with lithium, and thus is not a metal anode active material.

The anode active material layer 22 may include one kind of the anode active material selected from these anode active materials or a mixture of a plurality of different anode active materials. For example, the anode active material layer 22 may include only amorphous carbon or one or more selected from the group consisting of gold (Au), platinum (Pt), palladium (Pd), silicon (Si), silver (Ag), aluminum (Al), bismuth (Bi), tin (Sn), and zinc (Zn). Alternatively, the anode active material layer 22 may include a mixture of amorphous carbon and one or more selected from the group consisting of gold (Au), platinum (Pt), palladium (Pd), silicon (Si), silver (Ag), aluminum (Al), bismuth (Bi), tin (Sn), and zinc (Zn). The mixture of amorphous carbon and gold (Au) may be in a weight ratio of, for example, 10:1 to 1:2, 5:1 to 1:1 or 4:1 to 2:1. However, the mixing ratio is not limited to the range listed herein, and may be selected according to the required characteristics of the all-solid secondary battery 1. The all-solid secondary battery 1 may have improved cycle characteristics by the anode active material having such a composition.

The anode active material of the anode active material layer 22 includes, for example, a mixture of a first particle made of amorphous carbon and a second particle made of a metal or metalloid. The metal or metalloid may include, for example, gold (Au), platinum (Pt), palladium (Pd), silicon (Si), silver (Ag), aluminum (Al), bismuth (Bi), tin (Sn), and zinc (Zn), Alternatively, the metalloid is a semiconducting material. The content of the second particle is 8% to 60% by weight, 10% to 50% by weight, 15% to 40% by weight, or 20% to 30% by weight, based on a total weight of the mixture. When the content of the second particle is in the range listed above, the all-solid secondary battery 1 may have further improved cycle characteristics.

Examples of the binder included in the anode active material layer 22 may include, but not limited to, styrene-butadiene rubber (SBR), polytetrafluoroethylene, polyvinylidene fluoride, vinylidene fluoride/hexafluoropropylene copolymer, polyacrylonitrile, polymethymethacrylate, and so on, but any binder available in the art may be used as the binder. The binder may be composed of a single material or different binder materials used in combination.

The anode active material layer 22 is stabilized on the anode current collector 21 by the inclusion of the binder in the anode active material layer 22. In addition, in spite of a volumetric change and/or a relative location change during charging and discharging, cracking of the anode active material layer 22 can be suppressed. For example, when a binder is not included in the anode active material layer 22, the anode active material layer 22 may be easily separated from the anode current collector 21. As the anode active material layer 22 is separated from the anode current collector 21, the anode current collector 21 may be brought into contact with the solid electrolyte layer 30 at its exposed portion, thereby increasing a possibility of occurrence of short circuit. For example, the anode active material layer 22 is prepared by coating a slurry having constituent materials of the anode active material layer 22 dispersed therein on the anode current collector 21, followed by drying. Due to the inclusion of the binder in the anode active material layer 22, the anode active material may be stably dispersed in the slurry. For example, when the slurry is coated on the anode current collector 21 by screen printing, screen clogging (e.g., clogging by agglomerates of the anode active material) can be suppressed.

The anode active material layer 22 may further include additives used in the all-solid secondary battery 1, for example, a filler, a coating agent, a dispersant, or an ion conductive coagent.

The thickness of anode active material layer 22 may be 50% or less, 40% or less, 30% or less, 20% or less, 10% or less, or 5% or less of that of the cathode active material layer 12. The thickness of the anode active material layer 22 may be in a range of, for example, 1 μm to 20 μm, 2 μm to 10 μm, or 3 μm to 7 μm. If the anode active material layer 22 is extremely thin, a lithium dendrite formed between the anode active material layer 22 and the anode current collector 21 may collapse the anode active material layer 22, making it difficult to achieve improved cycle characteristics of the all-solid secondary battery 1. If the thickness of the anode active material layer 22 is excessively increased, the energy density of the all-solid secondary battery 1 may be lowered and the internal resistance of the all-solid secondary battery 1 is increased due to the anode active material layer 22, making it difficult to achieve improved cycle characteristics of the all-solid secondary battery 1.

If the thickness of the anode active material layer 22 is decreased, the charge capacity of the anode active material layer 22 may be reduced. The charge capacity of the anode active material layer 22 may be 50% or less, 40% or less, 30% or less, 20% or less, 10% or less, 5% or less, or 2% or less of the charge capacity of the cathode active material layer 12. The charge capacity of the anode active material layer 22 may be 0.1% to 50%, 0.1% to 40%, 0.1% to 30%, 0.1% to 20%, 0.1% to 10%, 0.1% to 5%, or 0.1% to 2% of the charge capacity of the cathode active material layer 12. If the charge capacity of the anode active material layer 22 is too small, the anode active material layer 22 may become extremely thin, a lithium dendrite formed between the anode active material layer 22 and the anode current collector 21 during repeated charging and discharging cycles may collapse the anode active material layer 22, making it difficult to achieve improved cycle characteristics of the all-solid secondary battery 1. If the charge capacity of the anode active material layer 22 is excessively increased, the energy density of the all-solid secondary battery 1 may be lowered and the internal resistance of the all-solid secondary battery 1 is increased due to the anode active material layer 22, making it difficult to achieve improved cycle characteristics of the all-solid secondary battery 1.

The charge capacity of the cathode active material layer 12 is obtained by multiplying a mass of the cathode active material in the cathode active material layer 12 with a charge capacity density (mAh/g) of the cathode active material layer 12. When multiple kinds of cathode active materials are used, a multiplication value is obtained by multiplying a mass for each of the cathode active materials with the charge capacity density, the obtained multiplication values of the respective cathode active materials are summed up, and the thus obtained sum corresponds to the charge capacity of the cathode active material layer 12. The charge capacity of the anode active material layer 22 is calculated in the same manner as in the cathode active material layer 12. That is to say, the charge capacity of the anode active material layer 22 is obtained by multiplying a mass of the anode active material in the anode active material layer 22 with the charge capacity density (mAh/g). When multiple kinds of anode active materials are used, a multiplication value is obtained by multiplying a mass for each of the anode active materials with the charge capacity density, the obtained multiplication values of the respective anode active materials are summed up, and the thus obtained sum corresponds to the charge capacity of the anode active material layer 22. Here, the charge capacity densities of the cathode active material and the anode active material are capacities estimated for an all-solid half-cell using a lithium metal as a counter electrode. The charge capacities of the cathode active material layer 12 and the anode active material layer 22 may be directly measured by measuring the charge capacities based on the all-solid half-cell. The charge capacity density of each of the cathode active material and the anode active material is obtained by dividing the measured charge capacity by the mass of each active material. Alternatively, the charge capacity density of each of the cathode active material and the anode active material may be an initial charge capacity measured at first cycle charging.

Referring to FIG. 9, an all-solid secondary battery 1a may further include, for example, a metal layer 23 between the anode current collector 231 and the anode active material layer 22. The metal layer 23 includes lithium or a lithium alloy. Thus, the metal layer 23 may function as a lithium reservoir, for example. Examples of the lithium alloy may include, but not limited to, a Li—Al alloy, a Li—Sn alloy, a Li—In alloy, a Li—Ag alloy, a Li—Au alloy, a Li—Zn alloy, a Li—Ge alloy, or Li−Si alloy, any suitable material available in the art may be used. The metal layer 23 may include one of these alloys or lithium, or various kinds of alloys.

The metal layer 23 may have a thickness in a range of, for example, 1 μm to 1000 μm, 1 μm to 500 μm, 1 μm to 200 μm, 1 μm to 150 μm, 1 μm to 100 μm, or 1 μm to 50 μm, but not limited thereto. If the thickness of the metal layer 23 is excessively small, it is difficult for the metal layer 23 to function as a lithium reservoir. If the thickness of the metal layer 23 is excessively large, the mass and volume of the all-solid secondary battery 1a may be increased and the cycle characteristics thereof may be lowered. The metal layer 23 may be, for example a metal foil having a thickness within the range stated above.

In the all-solid secondary battery 1a, the metal layer 23 may be disposed between the anode current collector 21 and the anode active material layer 22, for example, prior to assembling of the all-solid secondary battery 1, or may be precipitated between the anode current collector 21 and the anode active material layer 22 by a charging operation performed after assembling the all-solid secondary battery 1. When the metal layer 23 is disposed between the anode current collector 21 and the anode active material layer 22 prior to the assembling of the all-solid secondary battery 1a, the metal layer 23 containing lithium may function as a lithium reservoir. For example, prior to assembling of the all-solid secondary battery 1a, a lithium foil is disposed between the anode current collector 21 and the anode active material layer 22. As a result, the all-solid secondary battery 1a including the metal layer 23 may have further improved cycle characteristics. If the metal layer 23 is precipitated between the anode current collector 21 and the anode active material layer 22 by the charging operation performed after assembling the all-solid secondary battery 1a, the metal layer 23 is not included in the all-solid secondary battery 1a at the time of assembling the all-solid secondary battery 1a, and thus the energy density of the all-solid secondary battery la is increased. For example, when the all-solid secondary battery 1a is charged, the charging operation is performed so as to exceed the charge capacity of the anode active material layer 22. That is to say, the anode active material layer 22 is overcharged. In an initial charging stage, lithium is adsorbed into the anode active material layer 22 The anode active material in the anode active material layer 22 forms an alloy or a compound with lithium ions moving from the cathode layer 10. If the charging is performed so as to exceed the charge capacity of the anode active material layer 22, lithium is precipitated, for example, on a rear surface of the anode active material layer 22, that is, between the anode current collector 21 and the anode active material layer 22, and thus a metal layer corresponding to the metal layer 23 is formed by the precipitated lithium. The metal layer 23 is mainly made of lithium (i.e., a metal lithium). This result is obtained by the inclusion of the material that is alloyable with lithium or capable of forming a compound with lithium in the alloy anode active material layer 22. During discharging, lithium ions of the anode active material layer 22 and the metal layer 23, that is, lithium ions of a metal layer, migrate to the cathode layer 10. Therefore, lithium may be used as the anode active material in the all-solid secondary battery 1a. In addition, since the anode active material layer 22 coats the metal layer 23, it may also serve as a protection layer of the metal layer 23, while suppressing the precipitation growth of a lithium dendrite. Accordingly, the short-circuit and capacity reduction of the all-solid secondary battery 1a can be suppressed, consequently leading to improved cycle characteristics of the all-solid secondary battery 1a. In addition, when the metal layer 23 is disposed between the anode current collector 21 and the anode active material layer 22 by the charging operation performed after assembling the all-solid secondary battery 1a, the anode current collector 21, the anode active material layer 22 and a region therebetween are lithium-free regions at an initial state or at a discharged state of the all-solid secondary battery 1a.

The anode current collector 21 may include, for example, a material not reacting with lithium, that is, a material forming no alloy nor a compound. Examples of the material forming the anode current collector 21 may include, but not limited to, copper (Cu), stainless steel, titanium (Ti), iron (Fe), cobalt (Co) and nickel (Ni), and any suitable material that is used for an electrode current collector in the art, may be used. The anode current collector 21 may include one selected from the metals stated above or an alloy or coating material of two or more metals selected from the metals stated above. The anode current collector 21 may be, for example, a plate type or a foil type.

The all-solid secondary battery 1 or la may further include, for example, a thin film on the anode current collector 21, the thin film containing an element that is alloyable with lithium. The thin film is disposed between the anode current collector 21 and the anode active material layer 22. The thin film may include, for example, an element that is alloyable with lithium. Examples of the element that is alloyable with lithium may include, but not limited to, gold (Au), silver (Ag), zinc (Zn), tin (Sn), indium (In), silicon (Si), aluminum (Al), and bismuth (Bi), and any suitable element that is alloyable with lithium may be used. The thin film may be composed of one of the metals or alloys of various kinds of metals. The precipitation type of the metal layer 23 precipitated between the thin film 24 and the anode active material layer 22 may be further planarized by the disposition or arrangement of the thin film on the anode current collector 21, thereby further improving the cycle characteristics of the all-solid secondary battery 1.

The thin film may have a thickness in a range of, for example, 1 nm to 800 nm, 10 nm to 700 nm, 50 nm to 600 nm, or 100 nm to 500 nm. If the thickness of the thin film is less than 1 nm, the functionality of the thin film may not be demonstrated. If the thin film is overly thick, lithium may be absorbed by the thin film itself, the amount of lithium precipitated in the anode may be reduced, lowering the energy density of the all-solid secondary battery 1a, ultimately lowering the cycle characteristics thereof. The thin film may be disposed on the anode current collector 21 by, for example, vacuum evaporation, sputtering or plating. However, the thin film forming method is not limited thereto, and any suitable method known in the art may be used.

According to another embodiment, a preparation method of a solid ion conductor compound may include:

providing a mixture by contacting two or more compounds comprising: a lithium-containing compound; one or more compound containing an element, other than P, selected from elements belonging to Groups 3 to 15 in the periodic table and having an ionic radius larger than that of P; and different elements of Group 17 in the periodic table; and

thermally treating the mixture in an inert atmosphere in an inert atmosphere to provide the solid ion conductor compound.

The solid ion conductor compound may be, for example, a solid ion conductor compound represented by Formula 1.

The lithium-containing compound may include a lithium containing sulfide. As an example, lithium sulfide is mentioned.

The compound containing an element, other than P, selected from elements belonging to Groups 3 to 15 in the periodic table may include a sulfide containing an element selected from Group 3 to Group 15 elements and not including P. As an example, GeS₂, SiS₂, or SnS₂ is mentioned.

The compound containing P may include a sulfide containing P. As an example, P₂S₅ is mentioned.

The compound containing a Group 17 element includes a lithium salt containing a Group 17 element. As an example, LiCl, LiF, LiBr, or LiI is mentioned.

Such compounds may be prepared by contacting starting materials in an appropriate amount, for example, in a stoichiometric amount, to form a mixture, and thermally treating the mixture. The contacting may include, for example, milling, such as ball milling, or pulverizing.

A solid ion conductor compound may be prepared by thermally treating the mixture of precursors as the starting materials stoichiometrically mixed together in an inert atmosphere.

The thermal treatment may be performed at a temperature in a range of, for example, 400° C. to 700° C., 400° C. to 650° C., 400° C. to 600° C., 400° C. to 550° C., or 400° C. to 500° C. The thermal treatment may be performed for 1 to 36 hours, 2 to 30 hours, 4 to 24 hours, 10 to 24 hours, or 16 to 24 hours. The inert atmosphere may be an atmosphere having an inert gas. Examples of the inert gas may include, but not limited to, nitrogen or argon, and any suitable inert gas available in the art may be used.

The present inventive concept will be described in further details through the following examples and comparative examples. However, these examples are provided for illustrative purposes only and are not intended to limit the scope of the present inventive concept.

### (Preparation of Solid Ion Conductor Compounds)

### Example 1: Preparation of Li_{5.6} P_{0.9} Ge_{0.1} S_{4.5} Cl_{0.75} Br_{0.75}

Li₂S as a lithium (Li) precursor, P₂S₅ as a phosphorus (P) precursor, GeS₂ as a germanium (Ge) precursor, LiCl as a chlorine (Cl) precursor, and LiBr as a bromine (Br) precursor, were combined in glove box being in an inert atmosphere at a stoichiometric ratio to obtain a desired composition Li_{5.6} P_{0.9} Ge_{0.1} S_{4.5} Cl_{0.75} Br_{0.75}, and the obtained composition was milled and mixed with a planetary ball mill including zirconia (YSZ) balls in an argon (Ar) atmosphere for one hour at 800 rpm, followed by milling and mixing for 30 minutes at 800 rpm, thereby obtaining a mixture. The obtained mixture was pressed with a uniaxial pressure to prepare pellets having a thickness of about 10 mm and a diameter of about 13 mm. The prepared pellets were wrapped in a gold foil and then placed in a carbon crucible, and the carbon crucible was evacuated using a quartz tube. The evacuated pellets were heated using an electric furnace from at room temperature up to 500° C. at a rate of 1.0° C./min and then thermally heated at 500° C. for 12 hours, followed by cooling to room temperature at a rate of 1.0° C./min, thereby preparing a solid ion conductor compound.

The prepared solid ion conductor compound had a composition represented by Li_{5.6} P_{0.9} Ge_{0.1} S_{4.5} Cl_{0.75} Br_{0.75}, where a ratio of Ge substituted at P sites was 0.1, a ratio of total halogen elements substituted at S sites was 0.25, and Cl:Br=1:1.

### Example 2: Preparation of Li_{5.7} P_{0.8} Ge_{0.2} S_{4.5} Cl_{0.75} Br_{0.75}

A solid ion conductor compound having a composition represented by Li_{5.7} P_{0.8} Ge_{0.2} S_{4.5} Cl_{0.75} Br_{0.75}, where a ratio of Ge substituted at P sites was 0.2, was prepared in the same manner as in Example 1, except that the stoichiometric ratio of starting materials was so changed that the ratio of Ge substituted at P sites became 0.2.

### Example 3: Preparation of Li_{5.8} P_{0.7} Ge_{0.3} S_{4.5} Cl_{0.75} Br_{0.75}

A solid ion conductor compound having a composition represented by Li_{5.8} P_{0.7} Ge_{0.3} S_{4.5} Cl_{0.75} Br_{0.75}, where a ratio of Ge substituted at P sites was 0.3, was prepared in the same manner as in Example 1, except that the stoichiometric ratio of starting materials was so changed that the ratio of Ge substituted at P sites became 0.3.

### Example 4: Preparation of Li_{6.1} P_{0.9} Ge_{0.1} S₅ Cl_{0.5} Br_{0.5}

A solid ion conductor compound having a composition represented by Li_{6.1} P_{0.9} Ge_{0.1} S₅ Cl_{0.5} Br_{0.5}, where a ratio of Ge substituted at P sites was 0.1, a ratio of total halogen elements substituted at S sites was 1/6, and Cl:Br=1:1, was prepared in the same manner as in Example 1, except that the stoichiometric ratio of starting materials was so changed that the ratio of total halogen elements substituted at S sites became 1/6.

### Example 5: Preparation of Li_{5.6} P_{0.9} Ge_{0.1} S_{4.5} Cl1.5

A solid ion conductor compound was prepared in the same manner as in Example 1, except that the stoichiometric ratio of starting materials was so changed as to prepare a desired compound having a composition represented by Li_{5.6} P_{0.9} Ge_{0.1} S_{4.5} Cl_{1.5}, without adding LiBr.

The composition of the prepared solid ion conductor compound was Li_{5.6} P_{0.9} Ge_{0.1} S_{4.5} Cl_{1.5}, where a ratio of Ge substituted at P sites was 0.1.

### Example 6: Preparation of Li_{5.85} P_{0.9} Ge_{0.1} S_{4.75} Cl_{1.25}

A solid ion conductor compound was prepared in the same manner as in Example 1, except that the stoichiometric ratio of starting materials was so changed as to prepare a desired compound having a composition represented by Li_{5.85} P_{0.9} Ge_{0.1} S_{4.75} Cl_{1.25,} without adding LiBr.

The composition of the prepared solid ion conductor compound was Li_{5.85} P_{0.9} Ge_{0.1} S_{4.75} Cl_{1.25}, where a ratio of Ge substituted at P sites was 0.1.

### Comparative Example 1: Preparation of Li_{5.75} P₁ S_{4.75} Cl_{1.25}

A solid ion conductor compound was prepared in the same manner as in Example 1, except that the stoichiometric ratio of starting materials was so changed as to prepare a desired compound having a composition represented by Li_{5.75} P₁ S_{4.75} Cl_{1.25,} without adding GeS₂ and LiBr.

The composition of the prepared solid ion conductor compound was Li_{5.75}PS_{4.75}Cl_{1.25}.

### Comparative Example 2: Preparation of Li_{5.5} P₁ S_{4.5} Cl_{0.75} Br_{0.75}

A solid ion conductor compound was prepared in the same manner as in Example 1, except that the stoichiometric ratio of starting materials was so changed as to prepare a desired compound having a composition represented by Li_{5.5} P₁ S_{4.5} Cl_{0.75} Br_{0.75}, without adding GeS₂.

The composition of the prepared solid ion conductor compound was Li_{5.5} Pi S_{4.5} Cl_{0.75} Br_{0.75}.

### Comparative Example 3: Preparation of Li_{6.3} P_{0.2} Ge_{0.8} S_{4.5} Cl_{0.75} Br_{0.75}

A solid ion conductor compound having a composition represented by Li_{6.3} P_{0.2} Ge_{0.8} S_{4.5} Cl_{0.75} Br_{0.75}, where a ratio of Ge substituted at P sites was 0.8, was prepared in the same manner as in Example 1, except that the stoichiometric ratio of starting materials was so changed that the ratio of Ge substituted at P sites became 0.8.

### Example 6: Manufacture of All-Solid Secondary Battery

### (Preparation of Cathode Layer)

LiNi_{0.8}Co_{0.15}Al_{0.05}O₂ (NCA) was prepared as a cathode active material. The sulfide-based solid electrolyte powder prepared in Example 1 was prepared as a solid electrolyte. Carbon nanofiber was prepared as a conductive agent. These materials, that is, a cathode active material, a solid electrolyte and a conductive agent, were mixed at a weight ratio of 60:35:5, to prepare a cathode slurry.

### (Preparation of Solid Electrolyte Powder)

The sulfide-based solid electrolyte powder prepared in Example 1 was pulverized by using an agate mortar and used as solid electrolyte powder.

### (Preparation of Anode Layer)

A 30 μm metal lithium foil was prepared as an anode.

### (Manufacture of All-Solid Secondary Battery)

An anode layer, 150 mg of solid electrolyte powder and 15 mg of a cathode slurry were sequentially stacked on a stainless steel (SUS) lower electrode, and a SUS upper electrode was placed on the cathode slurry to prepare a stack structure, followed by pressing the prepared stack structure with a pressure of 4 ton/cm² for 2 minutes. Next, the pressed stack structure was pressed with a torque of 4 N·m using a torque wrench to prepare an all-solid secondary battery.

### Examples 8 to 10

All-solid secondary batteries were manufactured in the same manner as in Example 7, except that solid electrolyte powders prepared in Examples 2 to 4 were used, respectively, instead of the solid electrolyte powder prepared in Example 1.

### Comparative Examples 4 and 5

All-solid secondary batteries were manufactured in the same manner as in Example 7, except that solid electrolyte powders prepared in Comparative Examples 1 and 2 were used, respectively, instead of the solid electrolyte powder prepared in Example 1.

### Evaluation Example 1: Measurement of Ionic Conductivity and Activation Energy

Powders were prepared by pulverizing the solid ion conductor compound prepared in Examples 1 to 6 and Comparative Examples 1 to 3 using an agate mortar, 200 mg of the respective powders were pressed with a pressure of 4 ton/cm² for 2 minutes to prepare pellet samples having a thickness of about 0.900 mm and a diameter of about 13 mm. An indium (In) electrode having a thickness of 50 μm and a diameter of 13 mm was deposited on both surfaces of each of the prepared pellet samples to prepare a symmetric cell. The preparation of the symmetric cell was carried out in a glove box in an argon (Ar) atmosphere.

An impedance of each pellet sample with the indium electrode formed on opposite surfaces thereof was measured by a 2-probe method using a Material Mates 7260 impedance analyzer. A frequency range was from 0.1 Hertz (Hz) to 1 MegaHertz (MHz), and an amplitude voltage was 10 milliVolts (mV). The impedance was measured in an argon (Ar) atmosphere at 25° C. Resistance values were obtained from an arc of a Nyquist plot for the impedance measurement results and ionic conductivity of each sample was calculated therefrom. In addition, activation energy was calculated from the measurement results of the ionic conductivity.

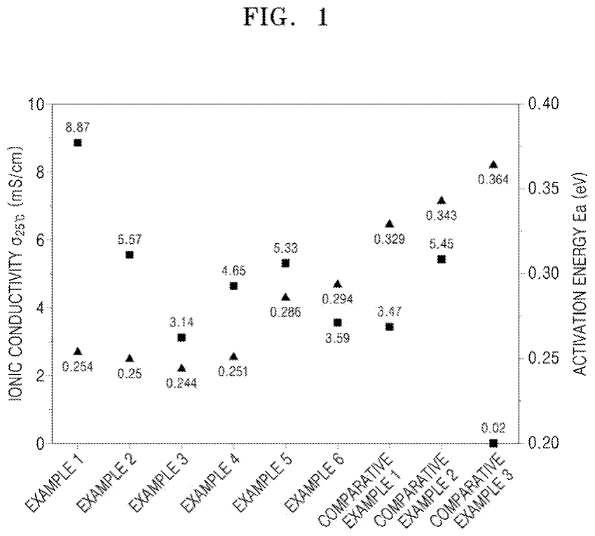

The measurement results of the ionic conductivity and , activation energy are shown in FIG. 1 and Table 1.

TABLE 1

| | Ionic conductivity at room | |
|---|---|---|
| | temperature (25° C.) | Activation energy |
| | [mS/cm] | [eV] |
| Example 1 | 8.87 | 0.254 |
| Example 2 | 5.57 | 0.250 |
| Example 3 | 3.14 | 0.244 |
| Example 4 | 4.65 | 0.251 |
| Example 5 | 5.33 | 0.286 |
| Example 6 | 3.59 | 0.294 |
| Comparative | 3.47 | 0.329 |
| Example 1 | | |
| Comparative | 5.45 | 0.343 |
| Example 2 | | |
| Comparative | 0.02 | 0.364 |
| Example 3 | | |

As shown in FIG. 1 and Table 1, the solid ion conductor compounds of Examples 1 to 6 exhibited a relatively high ionic conductivity of 3 mS/cm at room temperature.

When the solid ion conductor compounds of Example 1 and Comparative Example 2, the ionic conductivity was markedly increased from 5.45 mS/cm to 8.87 mS/cm by the substitution of 0.1 mol Ge, and the activation energy was reduced to about 70%, compared to the activation energy of the solid ion conductor compound of Comparative Example 2.

### Evaluation Example 2: Evaluation of Moisture Stability

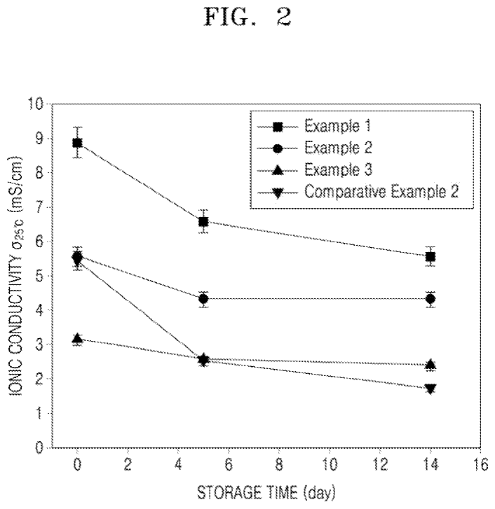

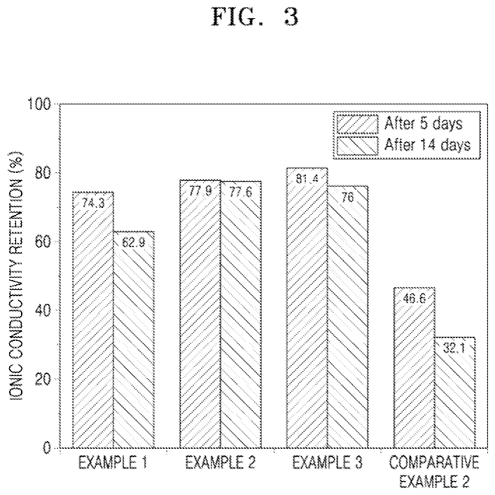

The solid ion conductor compounds prepared in Examples 1 to 3 and Comparative Example 2 were pulverized using an agate mortar to prepare powders, and the prepared powders were stored in a dry room while being exposed to air at a dew point of below −60° C. for 5 days and 14 days. Then, the compounds were taken out of the dry room to observe a change in the ionic conductivity. The change in the ionic conductivity was calculated using the ionic conductivity retention ratio expressed by Equation 1. The measurement results of the change in the ionic conductivity over storage time and the ionic conductivity retention ratio are shown in FIGS. 2 and 3. The ionic conductivity retention ratios are summarized in Table 2. The initial ionic conductivity was measured on the powder prepared before storage in the dry room. The ionic conductivity was measured in the same manner under the same conditions as in Evaluation Example 2.

Ionic conductivity retention ratio=[Ionic conductivity of solid ion conductor compound after 5 days or 14 days/Initial ionic conductivity of solid ion conductor compound]×100. <Equation 1>

TABLE 2

| | After 5 days | After 14 days |
|---|---|---|
| | Ionic conductivity | Ionic conductivity |
| | retention [%] | retention [%] |
| Example 1 | 74.3 | 62.9 |
| Example 2 | 77.9 | 77.6 |
| Example 3 | 81.4 | 76.0 |
| Comparative | 46.6 | 32.1 |
| Example 2 | | |

As shown in FIGS. 2 and 3 and Table 2, the solid ion conductor compounds of Examples 1 to 3 exhibited higher ionic conductivity than the solid ion conductor compound of Comparative Example 2.

In addition, the solid ion conductor compound of Comparative Example 2 demonstrated a significantly reduced ionic conductivity over storage time, compared to the solid ion conductor compounds of Examples 1 to 3.

The solid ion conductor compounds of Examples 1 to 3 demonstrated improved moisture stability of more than 2 times higher than the solid ion conductor compound of Comparative Example 2.

### Evaluation Example 3: Evaluation of Charging/Discharging Test and Oxidation Resistance

Oxidation resistance of each of the all-solid secondary batteries manufactured in Examples 7 to 10 and Comparative Examples 4 and 5 was evaluated by the following charging/discharging test. The charging/discharging test was conducted by placing each of the all-solid secondary batteries into a chamber maintained at a temperature of 45° C.

At a first cycle, each of the all-solid secondary batteries was charged with a constant current of 0.1 C and a constant voltage of 4.25 V until a battery voltage reached 4.25 V. Next, the all-solid secondary battery was discharged with a constant current of 0.1 C until the battery voltage reached 2.5 V.

A first cycle discharge capacity was defined as the standard capacity.

At a second cycle, each of the all-solid secondary batteries was charged with a constant current of 0.1 C and a constant voltage of 4.25 V for 50 hours until the battery voltage reached 4.25 V. Next, the all-solid secondary battery was discharged with a constant current of 0.1 C until the battery voltage reached 2.5 V.

A second cycle discharge capacity was defined as a retention capacity.

At a third cycle, each of the all-solid secondary batteries was charged with a constant current of 0.1 C and a constant voltage of 4.25 V until the battery voltage reached 4.25 V and the current voltage reached 0.05 C. Next, the all-solid secondary battery was discharged with a constant current of 0.1 C until the battery voltage reached 2.5 V.

A third cycle discharge capacity was defined as a recovery capacity.

A 10 minute pause was provided between each charging and discharging for each cycle.

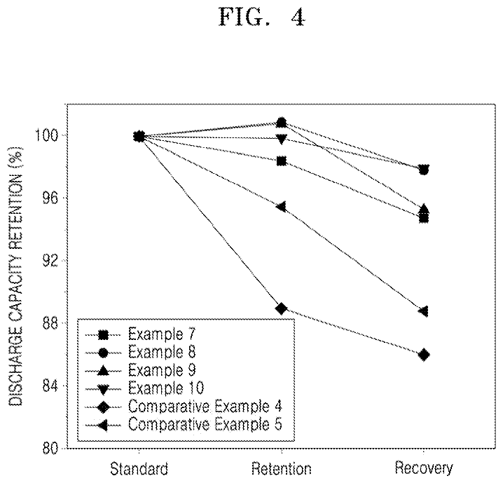

Measurement results of capacity recovery and retention ratios after high-temperature storage of the all-solid secondary batteries manufactured in Examples 7 to 10 and Comparative Examples 4 and 5, are shown in FIG. 4 and Table 3.

The capacity retention ratio after high-temperature storage and the capacity recovery ratio after high-temperature storage were calculated using Equations 2 and 3, respectively.

Retention capacity (%)=[Retention capacity/Standard capacity]×100 <Equation 2>

Recovery capacity (%)=[Recovery capacity/Standard capacity]×100 <Equation 3>

TABLE 3

| | Retention capacity [%] | Recovery capacity [%] |
|---|---|---|
| Example 7 | 98.37 | 94.76 |
| Example 8 | 100.87 | 97.81 |
| Example 9 | 100.79 | 95.31 |
| Example 10 | 99.85 | 97.97 |
| Comparative | 88.97 | 86.00 |
| Example 4 | | |
| Comparative | 95.46 | 88.81 |
| Example 5 | | |

As shown in FIG. 4 and Table 3, the all-solid secondary batteries of Examples 7 to 10 exhibited improved retention and recovery capacity ratios after high-temperature and long-time storage at a charged state, compared to the all-solid secondary batteries of Comparative Examples 4 and 5.

After storage at 45° C. for 50 hours, the solid secondary batteries of Examples 7 to 10 achieved higher capacities by greater than or equal to 10% than the solid secondary batteries of Comparative Examples 4 and 5. This suggests that the solid secondary batteries of Examples 7 to 10 have improved oxidation resistance (that is, stability at an anode interface), thereby improving high-voltage cell characteristics.

### Evaluation Example 4: Evaluation of Charging/Discharging Test and High-Rate Capabilities

High-rate characteristics of the solid secondary batteries of Examples 7, 8 and 10 and Comparative Example 5 were evaluated by the following charging/discharge tests. The charging/discharging test was conducted by placing each of the all-solid secondary batteries into a chamber maintained at a temperature of 25° C. Each of the all-solid secondary batteries was charged with a constant current of 0.1 C and a constant voltage of 4.25 V until a current value reached 0.05 C. Next, the all-solid secondary battery was discharged with a constant current of 0.05 C until the battery voltage reached 2.5 V. Thereafter, a charging operation was repeatedly performed under the same condition after each discharging operation, and discharging operations were conducted with constant currents of 0.33 C, 0.5 C, 1 C and 0.1 C, to observe changes in the capacity achieved according to the increase in the discharge rate.

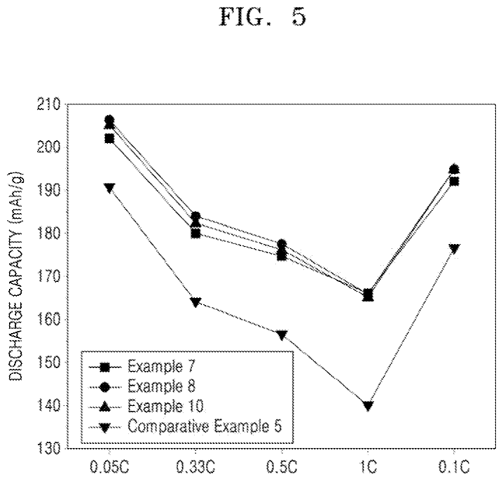

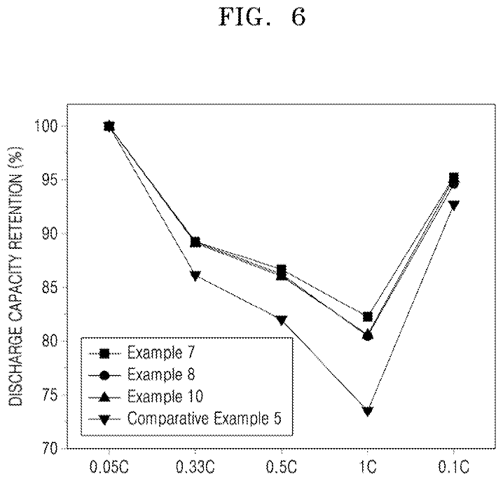

Discharge capacities and discharge capacity retention ratios of the solid secondary batteries of Examples 7, 8 and 10 and Comparative Example 5 were measured at various discharge rates, and the results thereof are shown in FIGS. 5 and 6.

As shown in FIGS. 5 and 6, the solid secondary batteries of Examples 7, 8 and 10 exhibited improved high rate characteristics, compared to the solid secondary battery of Comparative Example 5.

The solid secondary batteries of Examples 7, 8 and 10 had increased discharge capacity of about 10%, compared to the solid secondary battery of Comparative Example 5 (164 mAh/g), on the basis of 0.33 C discharge capacity (182 mAh/g).

In addition, the solid secondary batteries of Examples 7, 8 and 10 had an average discharge capacity efficiency of 91% at discharge rates of 1 C and 0.33 C, compared to 85% for the solid secondary battery of Comparative Example 5, conforming the rate capabilities thereof were improved.

As described above, the solid ion conductor compound according to one or more embodiments may have improved activation energy, moisture stability and oxidation stability, and thus can improve cycle characteristics of an electrochemical cell manufactured using the same.

While one or more exemplary embodiments have been described with reference to the figures, the embodiments described herein have been presented by way of example only, and it will be appreciated by those skilled in the art that various changes and other equivalent embodiments may be made from the above description. Therefore, the present disclosure should be defined by the spirit and scope of the appended claims.

1. A solid ion conductor compound represented by Formula 1 below and having an argyrodite-type crystal structure:
LiₓP_{y}M1ᵥS_{z}M2_{w}M3_{w′} Formula 1>
wherein, in Formula 1,
M1 is an element substituted at P sites and having a larger ionic radius than that of P,
M2 and M3 are different elements selected from elements of Group 17 in the periodic table, and
4≤x≤8, 0<y<1, 0<v<1, 0<z<6, 0<w<3, 0≤w′<3, and y≥v.

2. The solid ion conductor compound of claim 1, wherein in Formula 1, w+w′≥1.

3. The solid ion conductor compound of claim 1, wherein in Formula 1, 0<v/(y+v)<0.5 and 0.1≤(w+w′)/(z+w+w′)≤0.5.

4. The solid ion conductor compound of claim 1, wherein M1 is at least one element, other than P, selected from elements belonging to Groups 3 to 15 in the periodic table.

5. The solid ion conductor compound of claim 1, wherein M1 comprises Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, Bi, or a combination thereof.

6. The solid ion conductor compound of claim 1, wherein M1 comprises Si, Ge, Sn, or a combination thereof.

7. The solid ion conductor compound of claim 1, wherein M2 and M3 comprise different elements selected from F, Cl, Br, I, or a combination thereof.

8. The solid ion conductor compound of claim 1, wherein the solid ion conductor compound represented by Formula 1 is represented by Formula 2 below:
Li_{7+a-(b+c)}P₁₋ₐM1ₐS_{6-(b+c)}M2_{b}M3_{c} <Formula 2>
wherein, in Formula 2,
M1 is Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, Bi, or a combination thereof,
M2 and M3 different elements selected from F, Cl, Br, I, and a combination thereof, and 0<a≤0.5, 0<b<3, and 0≤c<3.

9. The solid ion conductor compound of claim 8, wherein in Formula 2, 0<a<0.5 and b+c≥1.

10. The solid ion conductor compound of claim 1, wherein the solid ion conductor compound represented by Formula 1 is represented by at least one of Formulae 2a to 2c below:
Li_{7+a-(b+c)}P₁₋ₐGeₐS_{6-(b+c)}M2_{b}M3_{c}; <Formula 2a>
Li_{7+a-(b+c)}P₁₋ₐSiₐS_{6-(b+c)}M2_{b}M3_{c}; and <Formula 2b>
Li_{7+a-(b+c)}P₁₋ₐSnₐS_{6-(b+c)}M2_{b}M3_{c} <Formula 2c>
wherein, in Formulae 2a, 2b, and 2c,
M2 and M3 are different elements selected from F, Cl, Br, I, and a combination thereof, and
0<a≤0.5, 0<b<3, 0≤c<3 and b+c≥1.

11. The solid ion conductor compound of claim 1, wherein:
the solid ion conductor compound represented by Formula 1 is represented by one of the formulae below:
Li_{7+a-(b+c)}P₁₋ₐGeₐS_{6-(b+c)}Cl_{b}Br_{c}; Li_{7+a-(b+c)}P₁₋ₐSiₐS_{6-(b+c)}Cl_{b}Br_{c}; Li_{7+a-(b+c)}P₁₋ₐSnₐS_{6-(b+c)}Cl_{b}Br_{c};
Li_{7+a-(b+c)}P₁₋ₐGeₐS_{6-(b+c)}Cl_{b}I_{c}; Li_{7+a-(b+c)}P₁₋ₐSiₐS_{6-(b+c)}Cl_{b}I_{c}; Li_{7+a-(b+c)}P₁₋ₐSnₐS_{6-(b+c)}Cl_{b}I_{c};
Li_{7+a-(b+c)}P₁₋ₐGeₐS_{6-(b+c)}Br_{b}I_{c}; Li_{7+a-(b+c)}P₁₋ₐSiₐS_{6-(b+c)}Br_{b}I_{c}; and Li_{7+a-(b+c)}P₁₋ₐSnₐS_{6-(b+c)}Br_{b}I_{c},
in the above formulae, 0<a≤0.5, 0≤b<3, 0≤c<3 and b+c≥1.

12. The solid ion conductor compound of claim 1, wherein the solid ion conductor compound represented by Formula 1 has some Li sites further substituted with at least one element M4 selected from elements of Groups 1 to 15 in the periodic table.

13. The solid ion conductor compound of claim 12, wherein the at least one element M4 includes Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof.

14. The solid ion conductor compound of claim 12, wherein in Formula 1, when a substitution amount of the at least one element M4 selected from elements of Groups 1 to 15 in the periodic table is denoted by u, 0<u<0.5.

15. The solid ion conductor compound of claim 1, wherein the solid ion conductor compound represented by Formula 1 has some S sites further substituted with SOₙ, in which 1.5≤n≤5.

16. The solid ion conductor compound of claim 15, wherein when an amount of the SOₙ is u′, 0<u′<2.

17. The solid ion conductor compound of claim 1, wherein the solid ion conductor compound represented by Formula 1 provides an ionic conductivity of 1.0 mS/cm or greater at 25° C.

18. The solid ion conductor compound of claim 1, wherein:
the solid ion conductor compound represented by Formula 1 has an ionic conductivity retention ratio of 70% or greater after exposure to dry air at a dew point of lower than −60° C. for 10 days, and
the ionic conductivity retention ratio is represented by Equation 1 below:
Ionic conductivity retention ratio=[Ionic conductivity of solid ion conductor compound after 10 days/Initial ionic conductivity of solid ion conductor compound]×100. <Equation 1>

19. A solid electrolyte comprising the solid ion conductor compound of claim 1.

20. An electrochemical cell comprising:
a cathode layer including a cathode active material layer;
an anode layer including an anode active material layer; and
an electrolyte layer disposed between the cathode layer and the anode layer,
wherein the cathode layer and the anode layer each include the solid ion conductor compound as claimed in claim 1.

21. The electrochemical cell of claim 20, wherein the electrochemical cell is an all-solid secondary battery.

22. The electrochemical cell of claim 20, wherein:
the anode active material layer includes an anode active material and a binder, and
the anode active material is a mixture of amorphous carbon and one or more of gold (Au), silver (Ag), aluminum (Al), bismuth (Bi), tin (Sn), and zinc (Zn).

23. The electrochemical cell of claim 20, further comprising a metal layer disposed between an anode current collector of the anode layer and the anode active material layer, wherein the metal layer comprises lithium or a lithium alloy.

24. A method of preparing a solid ion conductor compound, the method comprising:
providing a mixture by contacting two or more compounds comprising: a lithium-containing compound; one or more compounds containing an element, other than P, selected from elements belonging to Groups 3 to 15 in the periodic table and having an ionic radius larger than that of P; and different elements of Group 17 in the periodic table; and
thermally treating the mixture in an inert atmosphere to provide the solid ion conductor compound.

25. The method of claim 24, wherein the thermal treatment is performed at a temperature of 400° C. to 600° C. for 1 to 36 hours.
